(19) United States
(12) Patent Application Publication
(10) Pub. No.: US 2006/0068362 A1
(43) Pub. Date: Mar. 30, 2006

(54) Endodontic instrument with depth markers

(75) Inventors: John Joseph Desrosiers, Manhattan Beach, CA (US); Carlos A. Aloise, Alta Loma, CA (US); Gary T. Garman, La Verne, CA (US); Brian K. Glicker, Corona, CA (US)

Correspondence Address: WOOD, HERRON & EVANS, LLP, 2700 CAREW TOWER, 441 VINE STREET, CINCINNATI, OH, 45202, US

(73) Assignee: Ormco Corporation, Orange, CA (US)

(21) Appl. No.: 10/951,151

(22) Filed: Sep. 27, 2004

(51) Int. Cl. A61C 5/02

(52) U.S. Cl. 433/102

(57) ABSTRACT

An endodontic instrument includes an elongated shaft having a tip and a portion capable of being inserted into the root canal of a tooth. The shaft further includes a plurality of depth markers which are perceivable in a radiograph for indicating the depth of the tip within the root canal. The markers may comprise bumps having a diameter greater than the diameter of the elongated shaft by an amount sufficient to distinguish the markers from the shaft on the radiograph. Alternately, or additionally, the markers may have a radiopacity different from the radiopacity of the shaft by an amount sufficient to distinguish the markers from the shaft on the radiograph. The shaft may be selectively coated with paints, dyes, and/or inks having radiopaque properties. The markers may take the form of circumferential rings or other indicia such as numerals, letters and/or geometrical shapes.

### FIELD OF THE INVENTION

The invention relates generally to dental instruments and, more particularly, relates to endodontic instruments for extirpating pulp tissue and dentin from a root canal before obturating the root canal.

### BACKGROUND OF THE INVENTION

Successful root canal therapy effectively alleviates the pain and trauma originating from the decayed, damaged or dead circulatory and neural pulp tissue so that the tooth need not be extracted. After the pulp chamber, and subsequently the coronal root canal orifice(s), have been accessed during a root canal procedure, pulp tissue is extirpated from the root canal(s) of the tooth. Some surrounding dentin is also removed in the shaping of the root canal(s). After the root canal(s) have been sufficiently shaped and cleaned, sealant and obturation materials are used to fill and seal the root canal(s). To conclude the procedure, the access cavity in the coronal portion of the tooth is sealed using a restorative procedure to prevent future infection and decay.

Various endodontic instruments are employed to remove the pulp tissue and dentin from the root canal and to enlarge and shape the root canal in preparation for obturation. Conventional endodontic instruments, such as reamers or files, employed for extirpation during root canal therapy generally include a thin, flexible, metal shaft with an abrasive surface or sharp edges, which promotes efficient cleaning of the root canal. A shank at one end of the endodontic instrument is adapted for gripping by a dentist or attachment to a mechanical device such as a dental drill. Obturation material may be packed into the prepared root canal using similar endodontic instruments. Endodontic instruments are normally rotated and moved into and out of the root canal along the instrument's longitudinal axis.

During root canal therapy, the pulp material is removed from the full length of the root canal to the canal's apex. A problem that may be encountered during root canal therapy is apical perforation, i.e., excessive perforation of the apex of the root canal. Apical perforations typically result from pushing the tip of the endodontic instrument well beyond the apex of the canal, which not only exposes the periapical tissue to the infected debris, but also results in an enlarged and poorly shaped apex. The exposure to the infected debris may result in sensitivity and lengthen the healing process, while the enlarged and poorly shaped apex may result in a bad seal, leading to apical leakage and ultimately the need for retreatment or tooth extraction. Another problem relates to not introducing the file deep enough into the canal and failing to remove infected material from the vicinity of the apex, thereby leaving infected tissue within the root canal. The position of the tip of the endodontic instrument should be gauged relative to the apex of the canal so as to avoid significantly penetrating the apex while removing substantially all the pulp tissue from the root canal and sufficiently shaping the root canal.

Practitioners typically have at their disposal several techniques to determine the location of the apex. For example, many practitioners rely on an electronic apex locator to identify the location of the apex during a root canal procedure. Electronic apex locators, however, are costly and unreliable under some circumstances. Consequently, practitioners often resort to alternative techniques to determine the apex location or to confirm the readings made with the electronic apex locators.

A method of locating the apex without the use of an electronic apex locator may be accomplished, for example, in the following manner. The practitioner estimates the distance from a visible reference location, such as an occlusal landmark, to the apex utilizing a pre-operative radiograph of the tooth, and his/her education and experience. The practitioner then chooses an appropriate size endondontic instrument and places a moveable rubber stop on the shaft of the instrument at the estimated distance from the tip in order to indicate depth against the visible reference location, or datum. The practitioner works the instrument into the canal until the rubber stop reaches the datum and then takes a radiograph with the instrument remaining inside the tooth. Based on the information provided on the radiograph the practitioner may then, if required, adjust his/her estimate of the distance from the datum to the apex and alter the location of the rubber stop as necessary. The process is repeated as often as required until the practitioner can see on the radiograph that he/she has reached the desired depth with the appropriate size instrument. The practitioner can then determine the distance from the datum to the apex by removing the instrument from the patient's mouth and measuring the distance from the rubber stop to the tip of the instrument. The practitioner may then calculate and place, as appropriate, a moveable rubber stop on each successive instrument to be used in the procedure, and utilizing the rubber stops and the datum, he/she will shape the canal with the subsequent instruments as necessary.

A common problem with using moveable rubber stops to locate the apex is that after the radiograph is taken the rubber stop may be inadvertently moved by the patient while the instrument is still in the mouth, or by the practitioner while in the process of removing the instrument from the mouth, thereby rendering a false measurement. Another issue with using rubber stops is that they are generally too large to fit into the access cavity of the tooth and may be difficult to see on the radiographs. This precludes the practitioner from using the pulp chamber floor, which may be 10 to 15 millimeters closer to the apex than the occlusal landmark and be a significantly more planar surface, as the datum for measuring to the apex.

In the absence of a moveable rubber stop the practitioner may utilize, when present, a plurality of fixed visual markings on the shaft of the instrument, which are located at known distances from the tip of the instrument. These visual depth marks are typically circumferential rings inscribed into the shaft of the instrument using a laser marking process, or cut into the instrument with a cutting tool such as a grinding wheel. The advantage of using the visual markings that have been cut into the shaft is that, when sufficiently deep, the distinct reduction from the mean shaft diameter may be seen on a radiograph. The practitioner may therefore use the pulp chamber floor as the datum, taking advantage of its relatively flat surface and the fact that it is much closer to the apex than any occlusal features. The drawback to these cut-in depth marks is that to be readily identified on a radiograph their diameters must be significantly less than the mean shaft diameter, thereby weakening the overall structural integrity of the instrument. The likelihood of fracture at the groove locations therefore increases, subsequently resulting in a higher failure rate for these instruments.

In an effort to reduce the propensity for fracture, a manufacturer may create grooves just deep enough to be seen visually, but not radiographically. Likewise, the depth mark rings inscribed using a marking process such as laser marking do not significantly reduce the diameter of the instrument shaft thereby retaining its resistance to fracture, but also preclude the markings from being radiographically visible.

Visual depth markers that can not be seen on a radiograph have a number of additional drawbacks when used to identify the tip of the instrument relative to the apex of the root canal. First, in many situations the visual markers are difficult to see. This may be caused by the inability of the patient to open his/her mouth wide enough or may be due to the practitioner being poorly positioned to observe the markers. For instance, the inability to visualize the markers may occur when performing root canal therapy from the lingual side of a canine or incisor. Another drawback when using visual markers is that it is often difficult to find and maintain a reproducible reference datum for gauging the penetration depth. For instance, the jaggedness or irregularity of the crowns of molars make it difficult to specify a unique and repeatable datum. Additionally, a visual comparison between a marker and a reference datum often changes depending on the angle at which the comparison is made.

Thus, there would be a need for an endodontic instrument that overcomes these and other deficiencies of conventional approaches for apex location and provides for improved endodontic depth marking.

### SUMMARY OF THE INVENTION

The invention overcomes the foregoing and other shortcomings and drawbacks of conventional depth markers on endodontic instruments and conventional methods of determining apex location, as described above. According to the principles of the invention, an endodontic instrument includes a shank adapted for interfacing or gripping the instrument with a chuck or collet of a motorized rotary dental handpiece, or alternatively, for manually manipulating the instrument with a hand grip of some form, and an elongated shaft defining a longitudinal axis and coupled to the shank having a working length capable of being inserted into the root canal of a tooth. The elongated shaft also includes a shaft portion between the shank and working length, and a tip positioned at the distal end of the instrument, which would therefore be inside the root canal when the working length of the instrument is so inserted. The working length may include one or more edges adapted to extirpate tissue from the root canal when the shank is manipulated. The instrument further includes a plurality of markers on the shaft portion for indicating the depth of the tip in the root canal. Each marker is perceivable in a radiograph taken of the tooth when the distal portion of the instrument is inserted into the root canal.

In one embodiment of the invention, the markers project radially outward from the shaft portion by an amount sufficient to distinguish each marker from the shaft portion. For instance, the shaft portion may have a first diameter and the markers may have a second diameter greater than the first diameter. The shaft portion and markers are configured such that the plurality of markers define a first total length along the longitudinal axis, the shaft portion between the plurality of markers define a second total length along the longitudinal axis, where the second total length is greater than the first total length. The markers may be integrally formed with the elongated shaft or may be separate pieces, such as rings or bands, that may be coupled to the elongated shaft at selected positions. Due to cost, manufacturability and other considerations, the markers may be made from the same material as the elongated shaft or may be made from a different material.

In another embodiment, the radiopacity of each marker may differ from the radiopacity of the elongated shaft by an amount sufficient to distinguish the markers from the elongated shaft. This could be done, for example, by making the elongated shaft and markers out of materials having different radiopacities. Another way to do this, however, may be to selectively coat the elongated shaft with materials such as paints, dyes, inks or combinations of these substances, having a greater radiopacity. The markers may take the form of circumferential rings around the elongated shaft or may include other indicia, such as numerals, letters, geometric shapes or combinations of these indicia.

The plurality of markers of the invention may be used in conjunction with a selected datum to determine the depth of the instrument relative to the apex of the root canal. When the tip of the instrument nears the apex of the root canal, a practitioner will often take additional radiographs of the tooth while the endodontic instrument is disposed within the root canal. In the invention, as described herein, each marker on the instrument is clearly perceivable in the radiograph. Since there are multiple markers, each marker may be separated from an adjacent marker by a known amount. The plurality of markers will therefore provide a reference or scale for estimating the distance from the tip of the instrument to the apex of the root canal, as determined from the radiograph. In this way then, a practitioner can reasonably estimate how much further the instrument should penetrate into the root canal in order to reach the apex.

The above and other objects and advantages of the invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the invention.

FIG. 1 is a cross sectional view of a tooth and an endodontic instrument in accordance with the invention shown in use within a root canal;

FIG. 2 is a side view of an embodiment of an endodontic instrument according to the invention;

FIG. 2A is an enlarged view of a depth marker on the endodontic instrument of FIG. 2;

FIG. 2B is an enlarged view in partial cross section of a depth marker on an endodontic instrument similar to that shown in FIG. 2A;

FIG. 3 is a side view of an alternate embodiment of an endodontic instrument according to the invention;

FIG. 3A is an enlarged view of a depth marker on the endodontic instrument of FIG. 3;

FIG. 4 is a side view of another embodiment of an endodontic instrument according to the invention;

FIG. 4A is an enlarged view of a depth marker on the endodontic instrument of FIG. 4;

FIG. 5 is a side view of yet another embodiment of an endodontic instrument according to the invention; and

FIG. 5A is an enlarged view of a depth marker on the endodontic instrument of FIG. 5.

### DETAILED DESCRIPTION

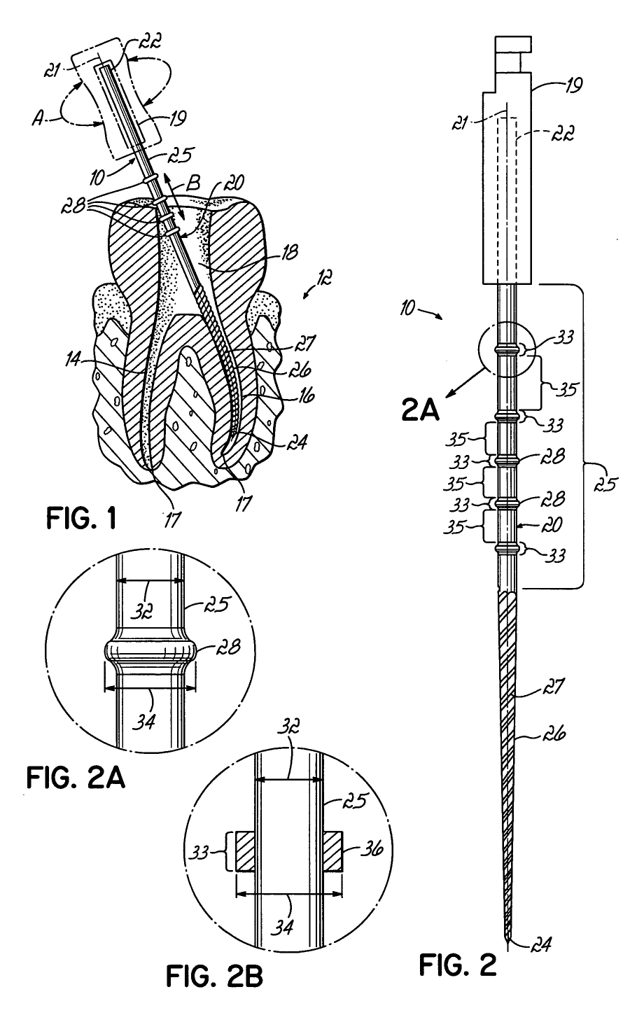

Referring first to FIG. 1, an endodontic instrument 10 constructed in accordance with an exemplary embodiment of the invention is shown being used during a root canal procedure on a tooth 12. Tooth 12 includes root canals 14 and 16 which terminate at the canal apex 17, and an upper interior cavity or pulp chamber 18 which has been initially opened using another instrument, such as a bur or drill (not shown). Instrument 10 includes an elongated shaft 20 defining a longitudinal axis 21, a proximal end 22 and a distal end or tip 24, and a portion 26 adjacent tip 24 capable of being inserted into root canals 14 and 16 of tooth 12. Portion 26 may include a working length 27 having a cutting edge adapted to extirpate tissue and dentin from root canals 14 and 16, although the invention is not so limited. A shank 19 is situated at the proximal end 22 of elongated shaft 20 and adapted for interfacing or gripping instrument 10 with a chuck or collet of a motorized rotary dental handpiece or, alternatively, of manually manipulating the instrument 10 with a handgrip of some form (shown in phantom). As can be appreciated by one of ordinary skill in the art, the elongated shaft 20 may be coupled to shank 19 through a frictional fit, adhesive bonding, or other known techniques, such as forming shank 19 and elongated shaft 20 as a unitary structure. A shaft portion 25 is defined between shank 19 and working length 27. Instrument 10 further includes a plurality of depth markers 28 along shaft portion 25 for indicating the depth of tip 24, as will be discussed in more detail below.

Manipulation of the instrument 10 for extirpating pulp tissue and dentin under conventional circumstances includes rotating the instrument 10 in the direction of arrows “A” and reciprocating the instrument 10 in the direction of arrows “B” by the practitioner to clean out and enlarge root canal 16.

As shown in the enlarged view of the elongated shaft 20 in FIG. 2, in which like reference numerals refer to like features in FIG. 1, a plurality of markers 28, are positioned along shaft portion 25 to aid the practitioner in determining the position of the tip 24 relative to the canal apex 17 of the root canal 16 from a radiograph. As used in the specification and claims, a radiograph is broadly defined to include not only an image produced on radiation sensitive films, such as traditional x-rays, but also electronically captured digital images, such as those captured by various CCD devices. A plurality of depth markers 28 may have known widths, and be separated or spaced apart at known intervals and correspond to known lengths from the tip 24 of instrument 10. For example, in an exemplary embodiment (not shown), four depth markers 28 may be provided along shaft portion 25 corresponding to distances from tip 24 of approximately 18 mm, 20 mm, 22 mm, and 24 mm. The invention, however, is not so limited and any number of depth markers 28 may be provided so long as the markers 28 are distinctly identifiable on a radiograph.

Depth markers 28 are advantageously adapted to be perceivable on a radiograph of the elongated shaft 20 and tooth 12 when tip 24 and portion 26 is inserted into root canal 16. In accordance with the invention, and as shown in FIGS. 2A and 2B, depth markers 28 may have a “bump” configuration wherein the markers 28 extend radially outward from shaft portion 25 by an amount sufficient to distinguish markers 28 from shaft portion 25 in the radiograph. The instrument 10 may have a constant diameter shaft portion 25, as shown in FIGS. 2A and 2B, and the bump may be created by shaft portion 25 having a shaft diameter 32 and the depth markers 28 having a maximum marker diameter 34 that is greater than shaft diameter 32 by an amount sufficient to distinguish marker 28 from shaft portion 25 in the radiograph.

Instrument 10 is not limited to a constant diameter shaft portion 25 and may have a diameter that varies between the shank 19 and the working length 27. In this case, for each specific marker 28, the marker diameter 34 must be greater than the shaft diameter 32 adjacent that specific marker 28 such that each marker 28 may be distinguished from shaft portion 25 in the radiograph. In either case, each marker diameter 34 is preferably between approximately 10% and approximately 100% larger than the shaft diameter 32 adjacent each marker 28. In this way, when a radiograph is taken with tip 24 and portion 26 inserted within root canal 16 of tooth 12, depth markers 28 are perceivable and identifiable on the radiograph. The bump configuration of the depth markers 28 in the invention is advantageous in that the marker diameter 34 has been increased over the shaft diameter 32, not decreased as in the grooved markers of prior instruments. As a result, the structural integrity of instrument 10 is not compromised by including depth markers 28.

As shown in FIG. 2, the shaft portion 25 and plurality of markers 28 may be configured such that the width, or length as measured along longitudinal axis 21, of the markers 28 is small when compared to the overall length of shaft portion 25. In other words, each marker 28 defines a first length 33 along longitudinal axis 21, each section of shaft portion 25 between adjacent markers 28 defines a second length 35 along longitudinal axis 21, such that the sum of the second lengths 35 is equal to the second total length, and the sum of the first lengths 33 is equal to the first total length where the second total length is greater than, and typically much greater than, the first total length.

The depth markers 28 may be incorporated into elongated shaft 20 in a variety of ways. For instance, as shown in FIG. 2B, depth markers 28 may comprise separate rings or bands 36, of linear length 33, coupled to shaft portion 25, such as by adhesives, at locations corresponding to known distances from tip 24. Due to costs, manufacturability and other considerations, rings or bands 36 may be made of a chemical composition different from the chemical composition of elongated shaft 20. By way of example, the bands 36 may be stainless steel while the elongated shaft 20 is a nickel titanium alloy. This configuration may be advantageous for reducing costs as well as simplifying manufacturing of instrument 10. In another embodiment, however, as shown in FIG. 2A, the depth markers 28 may be integrally formed in elongated shaft 20 to define a unitary instrument 10. For instance, markers 28 may be formed in elongated shaft 20 during machining of instrument 10.

In use and with reference to FIGS. 1 and 2, the markers 28 may be used to indicate the depth of the instrument tip 24 relative to the canal apex 17 of the root canal 16. Before a root canal procedure, a practitioner may take a pre-operative radiograph of the tooth 12 and make an estimate, depending on where the instrument will be inserted into tooth 12, of the distance from a reference point or datum to the apex 17 of the root canal 16. This estimate indicates approximately how deep the instrument tip 24 may penetrate into the root canal 16 such that the tip 24 of the instrument 10 is near the apex 17. The practitioner will then initiate shaping the root canal 16 until the instrument tip 24 may safely approach the apex 17. As mentioned previously, practitioners often rely on several approaches for determining the location of apex 17, such as electronic apex locators. Nevertheless, so as to avoid excessive penetration of the apex 17, practitioners may take additional radiographs to check or confirm the location of the tip 24 of the instrument 10 relative to the apex 17.

To do this, a practitioner will insert the instrument 10 into the root canal 16 of a patient's tooth 12 and take a radiograph while the instrument is disposed within the root canal. From the radiograph, the practitioner may readily identify the depth markers 28 along shaft portion 25 of elongated shaft 20 of the instrument 10. For example, because the markers 28 have a diameter 34 larger than the diameter 32 of the elongated shaft 20, such as that shown in FIGS. 2A and 2B, then “bumps” projecting radially outward from elongated shaft 20 and extending along a length of the image of the instrument 10 in the radiograph indicate the locations of markers 28. Once the markers 28 have been identified on the radiograph, the practitioner may make a reasonable estimate of how much further the instrument 10 may penetrate the root canal 16 in order to reach the canal apex 17. Because a plurality of markers 28 are used on the instrument, the markers 28 provide a reference or scale to aid in estimating this depth, which is independent of the magnification used in the radiograph. Thus two markers having a known separation distance, e.g. 1 mm, that appear on the radiograph provide a fixed visual scale that the practitioner may reference to more effectively estimate the lcoation of apex 17. In this way, the practitioner may shape and clean the root canal while reducing the likelihood of excessively perforating the apex.

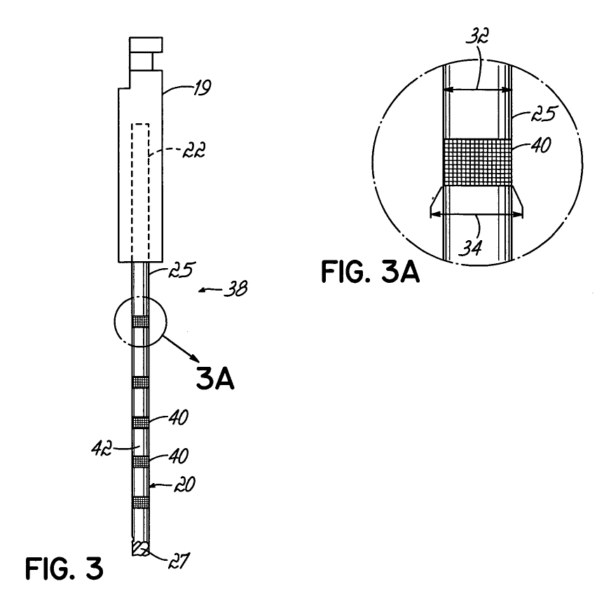

With reference to FIG. 3, in which like reference numerals refer to like features in FIG. 2, in another embodiment of the invention, endodontic instrument 38 includes a plurality of depth markers 40 positioned along elongated shaft 20. Depth markers 40 are spaced apart at known intervals and correspond to known lengths from the tip 24 of instrument 38. Depth markers 40 are advantageously adapted to be perceivable on a radiograph of the elongated shaft 20 and tooth 12 when tip 24 and portion 26 are inserted into root canal 16. In accordance with the invention, depth markers 40 are created by generally affecting the radiation properties of the markers 40 and/or elongated shaft 20. More particular, as shown in FIG. 3A, the depth markers 40 are formed by elongated shaft 20 having a first radiopacity and the depth markers 40 having a second radiopacity that differs from the first radiopacity by an amount sufficient to distinguish the markers 40 from elongated shaft 20 in a radiograph. For instance, if the depth markers 40 have a radiopacity greater than the radiopacity of the elongated shaft 20, the radiograph will have “bright spots” corresponding to the locations of markers 40. Conversely, if the depth markers 40 have a radiopacity less than the radiopacity of the elongated shaft 20, the radiograph will have “dark spots” corresponding to the locations of markers 40. In this way, when a radiograph is taken with tip 24 and portion 26 inserted within the root canal 16 of the tooth 12, depth markers 40 are perceivable and identifiable on the radiograph. While traditional x-ray film becomes darker with increased exposure to radiation, those of ordinary skill in the art will recognize that other scenarios are possible. For instance, films that become brighter with increased exposure to radiation may be used. Additionally, with respect to digital images, the captured image may be run through a wide variety of image processing algorithms that may, for example, manipulate or invert the image gray scale or contrast, or add colorations to the image.

The depth markers 40 may also be incorporated into elongated shaft 20 in a variety of ways. For instance, an elongated shaft 20 may be made from a first chemical composition having a first radiopacity while depth markers 40 may be made from a second chemical composition having a second radiopacity that differs from the first radiopacity. The markers 40 and elongated shaft 20 may be coupled during the manufacturing process of the instrument 38. When using radiopaque properties to identify markers 40, the diameter 32 of the elongated shaft 20 and the diameter 34 of depth markers 40 may be equal, such as that shown in FIGS. 3 and 3A. Alternatively, depth markers 40 may not only have a radiopacity different from the radiopacity of the elongated shaft 20, but may further have a diameter greater than that of the elongated shaft 20, such as that shown in FIG. 2B. This may be done, for example, by having separate bands or rings 36, with a radiopacity different than the radiopacity of the elongated shaft 20, coupled to elongated shaft 20 at positions corresponding to known distances from tip 24, similar to that shown in FIG. 2. In this way, two mechanisms are advantageously provided for indicating the markers in the radiograph.

Another method used to incorporate markers 40 into elongated shaft 20 is by coating elongated shaft 20 with a material having a radiopacity greater than the radiopacity of elongated shaft 20. This coating may include, for example, various paints, dyes or inks with known radiopaque properties. Thus, the markers 40, such as that shown in FIGS. 3 and 3A, may comprise circumferential bands made from paint, dye, ink, combinations thereof or other coating materials with radiopaque properties applied to the outer surface 42 of elongated shaft 20. Alternately, depth markers 40 may not only have a radiopacity greater than or less than the radiopacity of the elongated shaft 20, but may further have a diameter greater than that of the elongated shaft, such as that shown in FIGS. 2A and 2B. This may be done, for example, by coating the markers 28 or bands 36 in FIGS. 2A and 2B with a coating having a radiopacity greater or less than the radiopacity of elongated shaft 10. This again advantageously provides two mechanisms for identifying the markers in a radiograph.

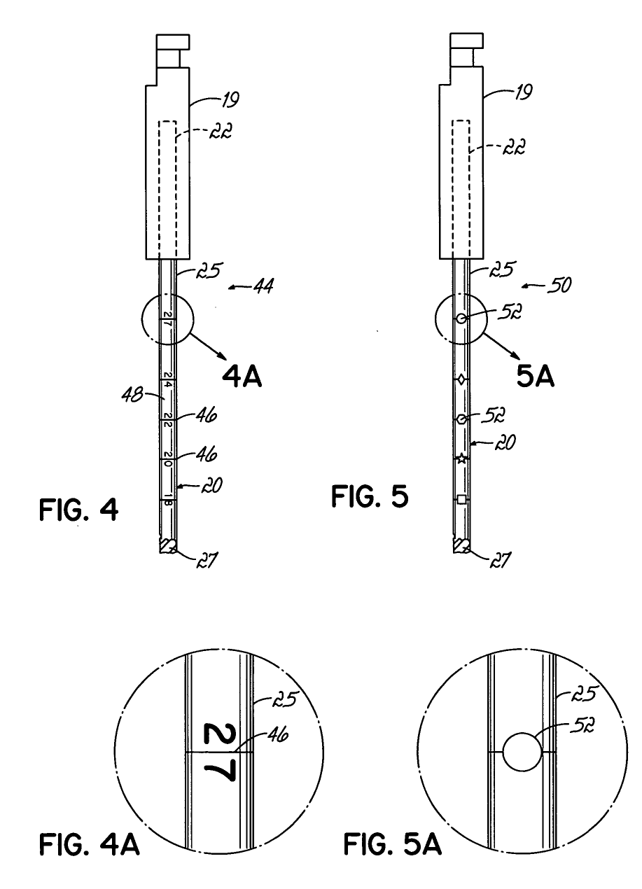

Alternate embodiments of endodontic instruments having depth markers comprising coating materials having a radiopacity greater than the radiopacity of elongated shaft 20 are shown in FIGS. 4 and 5, in which like reference numerals refer to like features in FIG. 2. As shown in FIGS. 4 and 4A, endodontic instrument 44 includes depth markers 46 comprising numeric indicia applied to the outer surface 48 of elongated shaft 20. The numeric indicia are applied using coating materials, such as various paints, dyes, inks, or combinations thereof, with radiopaque properties greater than the radiopacity of elongated shaft 20. These numeric indicia are then perceivable on a radiograph and provide the distance to the tip 24 of instrument 44. Likewise, as shown in FIGS. 5 and 5A, endodontic instrument 50 may include symbols 52 used as indicia of the depth markers along elongated shaft 20. It should be understood that a wide range of indicia may be used as depth markers including numerals, letters, geometric shapes, combinations thereof and other distinct and identifiable indicia.

As appreciated by those of ordinary skill in the art, the embodiments shown in FIGS. 3-5 may be used in a manner similar to that shown and described for the embodiment shown in FIG. 2. In reference to FIGS. 3-5, a practitioner can identify the markers 40, 46, 52 by noting contrast variations (e.g. gray scale variations) along the instrument 38, 44, 50 on the radiograph. For instance, if the markers 40, 46, 52 have a radiopacity greater than the elongated shaft 20 then “bright spots” along the instrument 38 indicate the locations of the markers. Conversely, if the markers 40 have a radiopacity less than the elongated shaft 20 then “dark spots” along the instrument 38 indicate the locations of the markers.

While the invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. For instance, the present invention may be incorporated into a wide range of endodontic instruments including not only reamers and files but also spreaders, pluggers, and others. The invention in its broader aspects is therefore not limited to the specific details, representative apparatus and methods, and illustrative examples shown and described. Accordingly, departures may be made from such details without departing from the spirit or scope of the applicants' general inventive concept.

What is claimed is:

1. An endodontic instrument configured for insertion within a root canal of a tooth while acquiring a radiograph of the tooth, the instrument comprising:
a shank for manipulating the instrument;
an elongated shaft defining a longitudinal axis and coupled to said shank, said elongated shaft including a working length capable of being inserted into the root canal of the tooth, a shaft portion between said shank and said working length, and a tip positioned inside the root canal when said working length is inserted therein; and
a plurality of markers on said shaft portion for indicating a depth of said tip in the root canal, said plurality of markers projecting outward from said shaft portion by an amount sufficient to distinguish said plurality of markers from said shaft portion in the radiograph;
wherein said plurality of markers define a first total length along said longitudinal axis, said shaft portion between said plurality of markers define a second total length along said longitudinal axis, and said second total length is greater than said first total length.

2. The endodontic instrument of claim 1, wherein said shaft portion has a first diameter, each of said plurality of markers has a second diameter greater than said first diameter by an amount sufficient to distinguish said plurality of markers from said shaft portion in the radiograph.

3. The endodontic instrument of claim 2, wherein said second diameter of each of said plurality of markers is between approximately 10 percent and 100 percent greater than said first diameter of said shaft portion.

4. The endodontic instrument of claim 1, wherein at least one of said plurality of markers comprises a ring coupled to said shaft.

5. The endodontic instrument of claim 1, wherein at least one of said plurality of markers is integrally formed with said shaft portion to define a unitary structure.

6. The endodontic instrument of claim 1, wherein said shaft portion has a first chemical composition and at least one of said plurality of markers has a second chemical composition that differs from said first chemical composition.

7. An endodontic instrument configured for insertion within a root canal of a tooth while acquiring a radiograph of the tooth, the instrument comprising:
an elongated shaft including a portion capable of being inserted into the root canal of the tooth and a tip positioned inside the root canal when said portion is inserted therein; and
a plurality of markers positioned on said shaft for indicating a depth of said tip in the root canal, said shaft having a first radiopacity and said plurality of markers having a second radiopacity that differs from said first radiopacity by an amount sufficient to distinguish said plurality of markers from said shaft in the radiograph.

8. The endodontic instrument of claim 7, wherein said second radiopacity is greater than said first radiopacity.

9. The endodontic instrument of claim 7, wherein said shaft has a first chemical composition having a first radiopacity and said plurality of markers have a second chemical composition having a second radiopacity.

10. The endodontic instrument of claim 7, wherein each of said plurality of markers includes a coating of a material having a second radiopacity.

11. The endodontic instrument of claim 10, wherein said material is selected from the group consisting of paint, dye, ink, and combinations thereof.

12. The endodontic instrument of claim 10, wherein at least one of said plurality of markers comprises:
a circumferential band around said shaft.

13. The endodontic instrument of claim 10, wherein at least one of said plurality of markers comprises:
an indicia selected from the group consisting of numerals, letters, geometric shapes, and combinations thereof.

14. The endodontic instrument of claim 7 further comprising:
a shank for manipulating the instrument, said elongated shaft coupled to said shank; and
a working length positioned along said portion, said plurality of markers positioned between said working length and said shank.

15. A method of estimating the distance between a tip of an endodontic instrument and an apex of a root canal of a tooth, the endodontic instrument carrying a plurality of markers perceivable in a radiograph of the tooth, the method comprising:
inserting the endodontic instrument into the root canal;
acquiring a radiograph of the tooth while the endodontic instrument is inserted into the root canal;
identifying the plurality of markers in the radiograph; and
determining the distance between the tip of the instrument and the apex of the tooth using the plurality of markers.

16. The method of claim 15, wherein identifying the plurality of markers in the radiograph comprises:
identifying a portion of the instrument having a diameter larger than the diameter of the instrument adjacent that portion.

17. The method of claim 15, wherein identifying the plurality of markers in the radiograph comprises:
identifying a portion of the instrument having one of a brighter or darker contrast in the radiograph than the contrast of the instrument adjacent that portion.

18. The method of claim 17, wherein identifying the portion of the instrument having one of a brighter or darker contrast in the radiograph comprises:
identifying a circumferential ring having an equal or greater diameter than the diameter of the instrument adjacent that portion.

19. The method of claim 17, wherein identifying the portion of the instrument having a brighter contrast in the radiograph comprises:
identifying an indicia selected from the group consisting of numerals, letters, geometric shapes and combinations thereof.

20. The method of claim 15, wherein determining the distance between the tip of the instrument and the apex using the plurality of markers comprises:
estimating a length between the tip of the instrument and the apex; and
comparing the length to the plurality of markers in the radiograph to determine the distance between the tip of the instrument and the apex.
